(19) United States
(12) Patent Application Publication
(10) Pub. No.: US 2011/0260807 A1
(43) Pub. Date: Oct. 27, 2011

(54) COMPACT ORTHO-MODE TRANSDUCER

(76) Inventor: Jose Maria Montero Ruiz, Arganda del Rey (ES)

(21) Appl. No.: 13/127,265

(22) PCT Filed: Nov. 3, 2008
(86) PCT No.: PCT/ES2008/070199

§ 371 Date: Jul. 15, 2011

(51) Int. Cl. H01P 5/12

(52) U.S. Cl. 333/117

(57) ABSTRACT

Ortho-mode transducer, with dual band frequency which is provided with a turnstile connection and an OMT-connection, where the ports of one of the bands or first band, are aligned with a longitudinal axis of the ortho-mode transducer arrangement, whereas the ports of the other band or second band, are arranged transversally to the longitudinal axis of the ortho-mode transducer, due to this configuration the branches from the turnstile connection to the OMT-connection are symmetrical two by two and compact having a C-shaped configuration and arranged so that they are facing two by two, with a dual Power Distribution circuit housed in an interior space defined by the branches or arms for the second band; due to this configuration, as well as reducing the space in a circular polarisation, neither sheet polarisers nor septums are required, and furthermore the transducer serves both for circular and linear polarisations.

### OBJECT OF THE INVENTION

The object of this invention is a compact ortho-mode transducer which has a high degree of symmetry and compressibility.

An ortho-mode transducer comprises a principal waveguide and two back to back guides. Two dominant orthogonal modes are propagated by the principal guide and each back to back guide may support one or both modes.

The functionality of the device consists of combining the entry signals in a common port maintaining all the entry ports insulated from each other.

Furthermore, the device has two-way direction, the signals entering the common port are separated according to frequency bands and polarisation of their respective entry ports.

The present invention is characterised by the special configuration and arrangement of the elements comprising the transducer which is the object of this invention, so that an easily mechanised compact transducer is obtained which is reduced in size and weighs little, with optimum electric functioning in broad band frequencies.

The object of the invention is also to provide the ortho-mode transducer with greater versatility enabling it to be used for different polarisations, that is, it can function with linear and circular polarisations.

Therefore, the present invention is circumscribed by the framework of ortho-mode transducers, and specifically of the type which work with two bands and at least one type of orthogonal polarisation.

### BACKGROUND TO THE INVENTION

Different multi-band orthogonal transducers are known in the state of the art, such as for example, that described in the US patent 2006226931 A1 which shows an ortho-mode transducer which uses a turnstile connection, and in which, although the branches are contained on a plane, they are not symmetrical and cross each other.

Other patents which present ortho-mode transducers are U.S. Pat. No. 6,150,899 A1, or EP patent 1369955 A2, which shows that the branches or arms present quite a complicated a path or routing structure.

All these ortho-transducers are provided with similar characteristics such as being based on branches or arms which have symmetrical pairs, however with a complex path or routing structure.

Other ortho-mode transducers based on a turnstile connection are provided with a very long structure if symmetrical arms are used, whereas the designs based on turnstile connections decentred from the axis require non-symmetrical pairs of arms.

Therefore, the object of this invention is to overcome the difficulties and disadvantages of orthogonal transducers existing to date, in which the complexity of the path or routing of the branches or areas where the structure of the pairs of branches is symmetric, both from an electrical and a physical perspective which makes manufacturing easier and provides greater compressibility and improved electrical performance in relative broad band frequencies.

### DESCRIPTION OF THE INVENTION

The object of the ortho-mode transducer invention basically consists of an ortho-mode transducer with a dual frequency band, where the ports of one of the bands or the first band are aligned with a longitudinal axis of the ortho-mode transducer arrangement, whereas the ports of the other band or second band are arranged transversally to the longitudinal axis of the ortho-mode transducer.

Said arrangement of the ports of each of the frequency bands permits a symmetrical and compact branch structure for the band which has the ports aligned with the longitudinal axis of the ortho-mode transducer arrangement, so that each of the branches is contained on a single plane and the arms of the branches do not cross over each other.

Thus the transducer is provided with two ports for one of the bands. For the first band, the ports are arranged in an aligned manner or parallel to the ortho-mode transducer axis, these ports are connected with a turnstile connection from which four equal arms emerge, symmetrical and compact which end in an OMT connection.

Each of the four arms or branches corresponding to the first frequency band is provided with a C-shaped configuration with one of its ends joined to the turnstile connection, whereas the other end is connected to the OMT connection.

Each of the branches or arms is contained on a plane, and they are arranged in such a way that they are facing two by two and separated by 90°.

In the interior space, defined as the volume limited by the four branches or arms which run from OMT to Turnstile connections, a Power Distribution Circuit (equipment or circuit which distribute the imput power from a single port to several outputs, controlling the signal amplitude and phase at each one to fulfil the requirements) is housed for the second band and which has the ports arranged transversally to the axis of the transducer arrangement. Said Power Distribution circuit is provided with a parallelepipedic configuration or with a rectangular prism which has entries from the second band arranged transversally to the longitudinal axis of the ortho-mode transducer arrangement.

As a result of this configuration, in the event that it is used with circular polarisation in the via of the first band, neither hybrids nor sheet polarisers are required, without septums. In addition, in the via of the second band neither sheet polarisations nor septums are used.

Due to the Power Distribution circuit configuration there are advantages for its mechanisation or construction, both in the case of constructing with planar technology (rectangular coax, stripline etc) such as in the case of its being constructed as a waveguide. In the latter case when the transversal Power Distribution circuit was a waveguide the advantages are clearer as they can be machined in two halves, attacking with machining tools perpendicular to the plane of the Power Distribution circuit, cutting the guide through the plane which does not have spurious radiation which makes the machining especially advantageous.

In addition to obtaining a compact ortho-mode transducer which has symmetrical branches, thus overcoming the complexity of paths or routing known to date, the object is to develop a transducer which is useful for both circular and linear polarisations.

In order to ensure that it works with both circular and linear polarisation for the first frequency band, it is sufficient to rotate the entry with respect to the Turnstile 45° connection.

For the second band it is sufficient to amend the internal distribution of the Power Distribution circuit in order to generate linear or circular polarisation in the outlet to the aerial.

### DESCRIPTION OF THE FIGURES

In order to complete the description below and to assist in a better comprehension of its characteristics, the present descriptive report is accompanied by a set of plans with figures representing in an illustrative, but not restrictive, way the most significant details of the invention.

FIG. 1, shows the electrical diagram of a traditional ortho-mode transducer with dual band and dual polarisation.

FIG. 2 shows a perspective view of the ortho mode transducer which is the object of the invention detailing some components.

FIG. 3 shows a ground view of the ortho-mode transducer which is the object of the invention.

FIG. 4 shows an electrical diagram of a dual Power Distribution circuit with four attack points.

FIG. 5 shows an electrical diagram of a dual Power Distribution circuit with three attack points.

### PREFERRED EMBODIMENT OF THE INVENTION

In the light of the figures below, a preferred embodiment of the proposed invention is described.

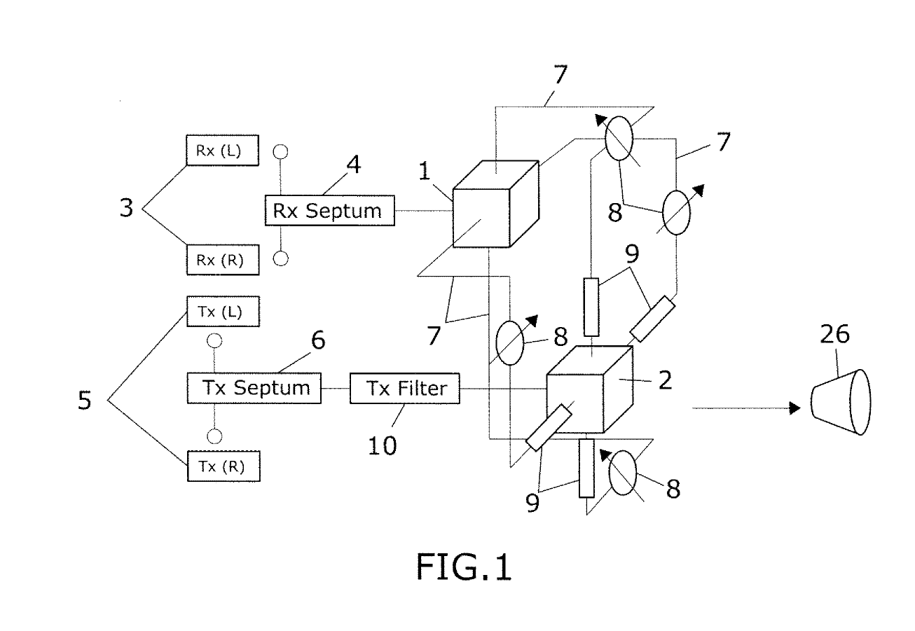

FIG. 1 shows an electrical diagram of a dual band and dual polarisation ortho-mode transducer as they have been constructed to date.

In said FIG. 1, we note that the ortho-mode transducer consists of a turnstile connection (1) and an OMT-connection (2). The entries (3) of each of the polarisations of one of the bands, and the first frequency band are connected to the turnstile connection (1) by means of a septum (4).

Furthermore, the entries (5) of each of the polarisations of the second band are connected to the OMT-connection (2) through a septum (6) and a filter (10).

The connection between the turnstile connection and the OMT connection (2) is made by means of four branches (7). The customary distribution of the elements do not permit these branches to be perfectly symmetrical with each one being provided with bends on two different planes.

Prior to connection of the branches (7) to the OMT-connection (2) there are some phase adjusters (8) or trimming connected serially with filters (9). The first trimmings are used to finely adjust the phase of each branch and the second (filters) in order to prevent the route of one of the bands to the other band.

The OMT-connection is connected to an aerial (26) which works with both bands which could be transmission or reception.

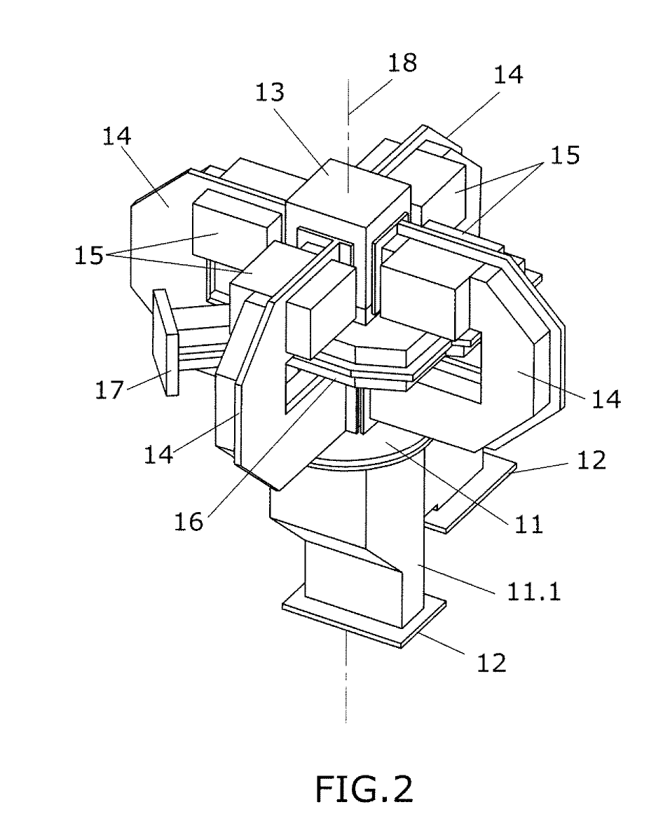

FIG. 2 shows the configuration adopted by the ortho-mode transducer which is the object of the invention, where it also has a turnstile connection (11) and an OMT-connection (13). The entries (12) of one of the bands are connected to the turnstile connection.

Both the turnstile connection (11) and the OMT connection (13) and the entries (12) are aligned according to the longitudinal axis (18) of the arrangement.

It is possible to note that the connection branches or arms (14) between the turnstile connection (11) and the OMT-connection (13) prior to their connection with the OMT-connection are provided with filters (15). Said branches or arms (14) are provided with a C-shaped configuration, and they are equal, symmetric and contained on a plane which permits a simple and compact configuration to be obtained.

Due to the fact that the branches (14) are provided with a C-shaped configuration, are equal, symmetric and contained in a plane, and are arranged facing each other, in the interior space defined by the branches (14) it is possible to house a Power Distribution circuit (16) of the other band. This Power Distribution circuit (16) is provided with a flat configuration in the form of a rectangular prism in which the entries to said Power Distribution circuit of the other band are transversal to the longitudinal axis (18) of the arrangement.

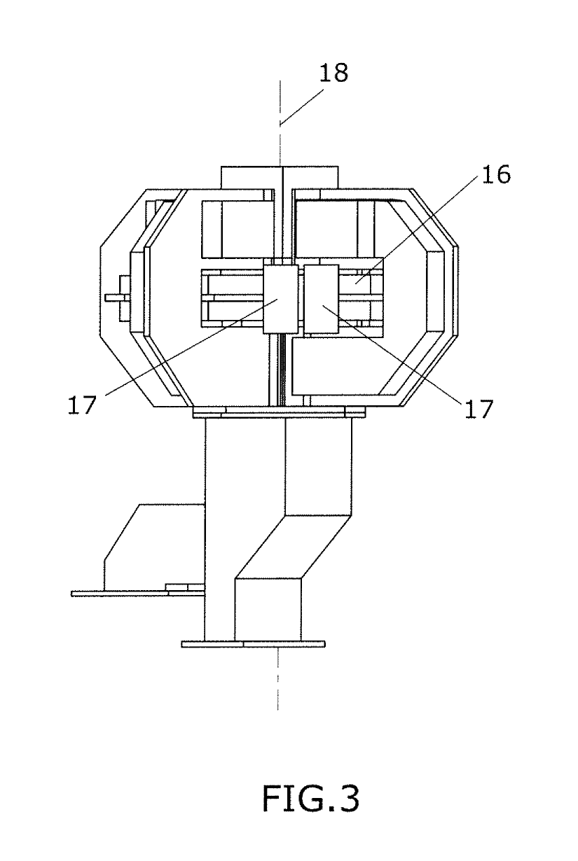

FIG. 3 shows a front view which confirms how the entry ports or entries (17) of one of the bands are arranged in a manner transversal to the longitudinal axis (18) of the arrangement.

Due to this configuration described, in the event of being used with circular polarisation, the band fed through the ports (12) does not require hybrids, or sheet polarisers, nor septums, nor in the other band, the second band, are sheet polarisers or septums required.

The arrangement may additionally be extremely versatile with respect to the polarisations with which it may operate, so that it may work in both circular and linear polarisation. As represented in FIG. 3 it works in circular polarisation, and in order to be able to do it in linear polarisation it is sufficient to rotate the part (11.1) previous to the turnstile by 45°. Additionally, with the simple modification of the entry coupler of the Power Distribution circuit (16) we would also pass from a circular to a linear feed in this frequency band. The modification of the entry coupler of the Power Distribution circuit consists of modifying their distribution of couplings, phases and equalisers.

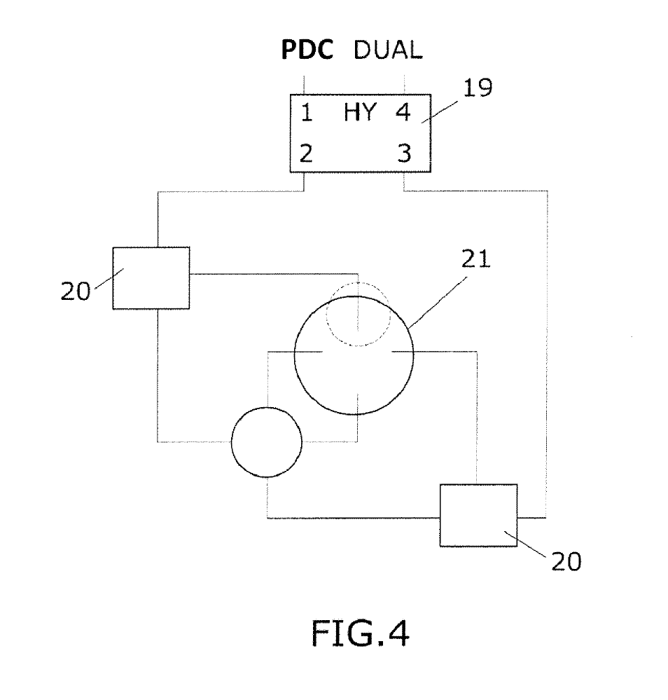

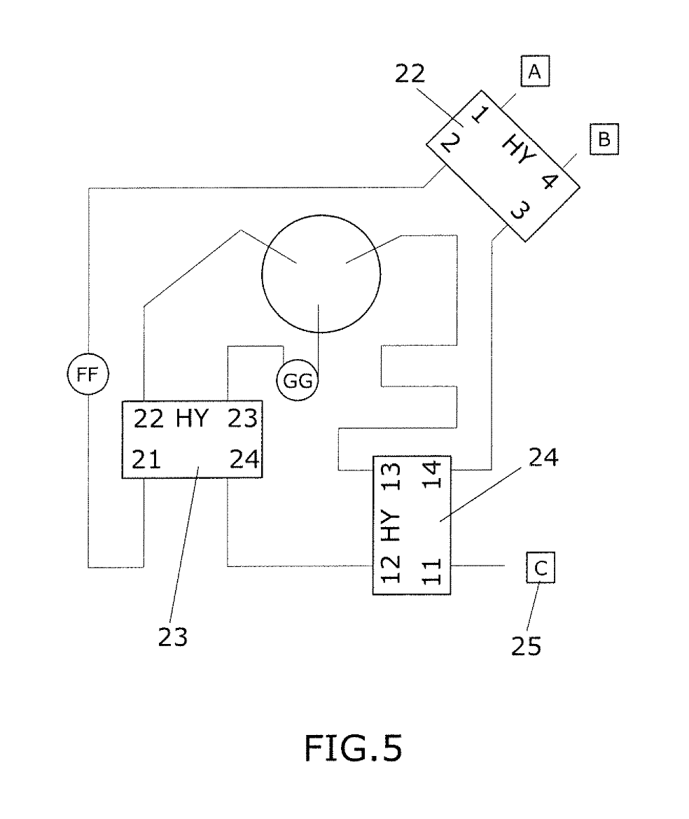

FIGS. 4 and 5 show the necessary elements housed in the dual Power Distribution circuit (16) in order to correctly supply the signals to the OMT-connection. In FIG. 4 the Power Distribution circuit (16) consists of a hybrid (19) whose outlets are connected to splitters (20) which divide the signal and permit separation of one polarisation from another, connecting a connection (21) with the OMT-connection.

This configuration shown in FIG. 4 is complex and there is a risk of signal points.

FIG. 5 shows how, on the basis of entry ports or entries (17) of one of the bands, each of the polarisations is separated, in this case using three couplers (22, 23 and 24) and equalised interconnection lines, in order to provide the required signal distribution according to the desired (linear or circular) polarisation where the coupler (24) has a loaded port (25) at one of its entries.

The essential nature of this invention is not altered by any variations in materials, form, size and arrangement of its component elements, which are described in a non-restrictive manner, with this being sufficient to proceed to its reproduction by an expert

What is claimed is:

1. Compact ortho-mode transducer with dual band frequency which is provided with a turnstile connection and an OMT-connection wherein one of the bands or first band is provided with ports connected to the turnstile connection where said ports are aligned with a longitudinal axis of the ortho-mode transducer arrangement, whereas the other band or second band is provided with ports arranged transversally to the longitudinal axis of the ortho-mode transducer, characterized in that:
It has double polarization in each band having;
four compact symmetrical arms emerge from the turnstile connection two by two and finalise in an OMT connection, wherein
each of the four arms or branches has a C-shaped configuration and
one of the branches or arms is contained on a plane, and they are arranged in such a way that they are facing two by two and separated by 90°, and
the interior space defined by the four branches or arms houses a dual Power Distribution circuit for the second band and which is provided with ports arranged in a manner transversal to the axis of the transducer arrangement.

2. Compact ortho-mode transducer according to claim 1 characterised in that said Power Distribution circuit is provided with a parallelepipedic configuration or with a rectangular prism which has entries from the second band arranged transversally to the longitudinal axis of the ortho-mode transducer arrangement.

3. Compact ortho-mode transducer according to claim 2 characterised in that the Power Distribution circuit comprises three couplers (22, 23 and 24) and equalised interconnection lines in order to give the required distribution signal according to the desired (linear or circular) polarisation.

4. Compact ortho-mode transducer according to claim 1 characterised in that the compact ortho-mode transducer may be used for both circular and linear polarisations, amending the internal distribution of the Power Distribution circuit for the second band.

5. Compact ortho-mode transducer according to claim 2 characterised in that said Power Distribution circuit could be carried out in different technologies: rectangular waveguide, coaxial o stripline.
